(19) United States
(12) Patent Application Publication
(10) Pub. No.: US 2017/0047021 A1
(43) Pub. Date: Feb. 16, 2017

(54) DISPLAY DEVICE

(71) Applicant: SHARP KABUSHIKI KAISHA, Sakai City, Osaka (JP)

(72) Inventor: Masafumi YASHIKI, Sakai City (JP)

(73) Assignee: Sharp Kabushiki Kaisha, Sakai City, Osaka (JP)

(21) Appl. No.: 15/305,445

(22) PCT Filed: May 28, 2015
(86) PCT No.: PCT/JP2015/065352

§ 371 Date: Oct. 20, 2016

(30) Foreign Application Priority Data
Jun. 4, 2014 (JP) 2014-115501

(51) Int. Cl. G09G 3/34; G09G 3/20; G09G 3/36

(52) U.S. Cl. CPC G09G 3/3413; G09G 3/3607; G09G 3/2003; G09G 3/3614; G09G 2310/0235; G09G 2300/0452; G09G 2320/0233; G09G 2310/08

(57) ABSTRACT

There is provided a field-sequential-system display device that reduces or eliminates a color mixture phenomenon while suppressing a reduction in luminance. In a field-sequential-system liquid crystal display device, when one frame period is divided into three subframe periods, red, green, and blue backlights are lit during light-on periods which are the second half of a first to a third subframe period, and the operation of writing an image to pixel formation portions is performed twice using two scanning periods each being shorter in length than the first half of each subframe period. By this configuration, pixel voltages are securely written to pixel capacitances, and color mixture with a color in a previous subframe period is prevented by a period other than a light-on period.

### TECHNICAL FIELD

The present invention relates to a display device, and more particularly to a display device such as a liquid crystal display device that performs color display using a field sequential system.

### BACKGROUND ART

Most of liquid crystal display devices that perform color display include color filters that allow red (R), green (G), and blue (B) lights to be transmitted therethrough for three subpixels into which one pixel is divided. However, since about two-thirds of backlight light that is irradiated onto a liquid crystal panel is absorbed by the color filters, the color-filter-system liquid crystal display devices have a problem of low light use efficiency. Hence, attention is focused on a field-sequential-system liquid crystal display device that performs color display without using color filters.

In the field sequential system, a display period (one frame period) of one screen is divided into three subframe periods. A red image depending on a red component of an input signal is displayed during a first subframe period, a green image depending on a green component of the input signal is displayed during a second subframe period, and a blue image depending on a blue component of the input signal is displayed during a third subframe period, by which a color image is displayed on a liquid crystal panel. As such, the field-sequential-system liquid crystal display device does not require color filters and thus has light use efficiency that is about three times as high as the color-filter-system liquid crystal display device.

However, since the field sequential system performs display using an eye's afterimage effect by switching between the first to third subframe periods at high speed, it is known that display abnormality based on eye's characteristics can occur. Phenomena causing display abnormality include, for example, a color breakup phenomenon where color variation occurs in a line-of-sight movement direction due to irregular movement of the line of sight, a color mixture phenomenon that occurs due to the lower side of a display screen displayed later than the upper side of the display screen, and a color shift (motion blur) phenomenon that occurs due to movement of an image to be displayed.

For the above-described color breakup phenomenon, there is a field-sequential-system liquid crystal display device that divides one frame period into four or five or more subframe periods and assigns white (W) in addition to red, green, and blue to the subframe periods. By thus assigning white, color variation is visually suppressed and accordingly the color breakup phenomenon is reduced.

In addition, Japanese Patent Application Laid-Open No. 2007-206698 also discloses a liquid crystal display device configured to divide one frame period into four subframe periods where any one of three colors including red (R), green (G), and blue (B) is further added to red (R), green (G), and blue (B). By this configuration, too, likewise, the color breakup phenomenon is reduced and the occurrence of color flicker can be suppressed.

In addition, Japanese Patent Application Laid-Open No. 2000-214829 discloses a configuration of a field-sequential-system liquid crystal display device that allows an image which is displayed during each subframe period to move by a predetermined amount depending on the amount of movement of an image to be displayed. By this configuration, a color shift (motion blur) associated with movement of an image is suppressed.

### PRIOR ART DOCUMENTS

### Patent Documents

[Patent Document 1] Japanese Patent Application Laid-Open No. 2007-206698

[Patent Document 2] Japanese Patent Application Laid-Open No. 2000-214829

### SUMMARY OF THE INVENTION

### Problems to be Solved by the Invention

Here, the above-described color mixture phenomenon occurring when an image is displayed on a conventional field-sequential-system liquid crystal display device will be specifically described. Note that in the following description it is assumed that each of a red component, a green component, and a blue component of an input signal which is provided to the liquid crystal display device from an external source is 8-bit data. Therefore, the liquid crystal display device displays each color of red, green, and blue in 256 gray scales.

A case will be described in which an image where the transmittance of a liquid crystal panel significantly changes between adjacent subframe periods is displayed on the liquid crystal display device. FIG. 8 is a diagram showing display luminance at the first row of a liquid crystal panel for each subframe period for when a red still image is displayed on a conventional field-sequential-system liquid crystal display device that sequentially displays red, green, and blue. In addition, FIG. 9 is a diagram showing display luminance at the last row of the liquid crystal panel for each subframe period for when a red still image is displayed on the liquid crystal display device. Note that the horizontal axis of graphs shown in FIGS. 8 and 9 represents time and the vertical axis thereof represents the transmittance of the liquid crystal panel.

As shown in FIG. 8, when an image with a red gray scale value of 255 and green and blue gray scale values of 0 is displayed on the first row of the liquid crystal panel, a red component with a red gray scale value of 255 is provided and a red backlight emits light during the second-half period of a first subframe period. Here, the transmittance of the liquid crystal panel increases with time from 0% obtained at time t0 and reaches 100% after a lapse of a predetermined period of time (here, time t1). By this, red light from the red backlight is transmitted through the liquid crystal panel and a red image with a gray scale value of 255 is displayed on the first row of the liquid crystal panel.

On the other hand, as shown in FIG. 9, when an image with a red gray scale value of 255 and green and blue gray scale values of 0 is displayed on the last row of the liquid crystal panel, a red component with a red gray scale value of 255 is provided and the red backlight emits light during the second-half period of the first subframe period. Here, the transmittance of the liquid crystal panel increases with time from 0% obtained at time t1 and reaches 100% after a lapse of a predetermined period of time (here, time t2).

However, the transmittance of the liquid crystal panel essentially needs to be 100% while the red backlight is lit. Despite this, even when a red component with a red gray scale value of 255 is provided, the transmittance of the liquid crystal panel never instantaneously reaches 100% from 0% in the first subframe period. Therefore, red light from the red backlight that is supposed to be transmitted through the liquid crystal panel during this period lacks luminance, resulting in displaying a dark red image on the last row of the liquid crystal panel during a period from time t1 to immediately before time t2.

Subsequently, during the second-half period of a second subframe period, a green backlight emits light and a green component with a green gray scale value of 0 is provided. Here, as shown in FIG. 8, for the first row of the liquid crystal panel, when the green backlight is lit (time t3), the transmittance of the liquid crystal panel reaches 0% and light from the green backlight is blocked by the liquid crystal panel and thus a green image is not displayed. However, as shown in FIG. 9, for the last row of the liquid crystal panel, when the green backlight is lit (time t3), even when a green component with a green gray scale value of 0 is provided, the transmittance of the liquid crystal panel never instantaneously reaches 0% from 100% in the second subframe period. As such, since the transmittance of the liquid crystal panel in the second subframe period is affected by the transmittance in the first subframe period, a predetermined period of time (here, a period of time from time t3 to t4) is required for the transmittance of the liquid crystal panel to reach 0% as it should be. During this period, a part of green light from the green backlight that is supposed to be blocked by the liquid crystal panel is transmitted, resulting in displaying a green image on the last row of the liquid crystal panel. As a result, a viewer ends up viewing an image where green is mixed into red near the last row of the liquid crystal panel, decreasing color reproducibility.

In this regard, the configurations of the liquid crystal display devices described in the above-described Japanese Patent Application Laid-Open No. 2007-206698 and Japanese Patent Application Laid-Open No. 2000-214829 cannot prevent color mixture such as that described above. In addition, by setting shorter light-on periods of the backlights, a period during which color mixture occurs can be made shorter, and thus, a reduction in color mixture can be achieved. This, on the other hand, decreases overall luminance of the liquid crystal panel and thus display quality decreases.

An object of the present invention is therefore to provide a field-sequential-system display device that reduces or eliminates a color mixture phenomenon while suppressing a reduction in overall luminance of a liquid crystal panel.

### Means for Solving the Problems

A first aspect of the present invention is directed to a display device that divides one frame period into a plurality of subframe periods and displays an image of any of a plurality of colors on a subframe-period-by-subframe-period basis, the display device including:

a plurality of pixel formation portions arranged along a plurality of video signal lines for transmitting a plurality of video signals and along a plurality of scanning signal lines intersecting the plurality of video signal lines;

a video signal line drive circuit configured to drive the plurality of video signal lines, based on the plurality of video signals;

a scanning signal line drive circuit configured to selectively drive the plurality of scanning signal lines;

a display control circuit configured to provide image signals to the video signal line drive circuit based on an input signal, the image signals being for controlling light transmittances of the plurality of pixel formation portions such that the image is displayed on a subframe-period-by-subframe-period basis;

a light source configured to emit light that is to be transmitted through the pixel formation portions; and

a light source control circuit configured to assign any of the plurality of colors on a subframe-period-by-subframe-period basis and control the light source to emit light of the assigned color, wherein

the scanning signal line drive circuit selectively drives all of the plurality of scanning signal lines during a selection period, the selection period being shorter in length than first half of each of the subframe periods,

the video signal line drive circuit provides video signals for displaying an image of an assigned color to the plurality of video signal lines every time the plurality of scanning signal lines are selectively driven by the scanning signal line drive circuit, and

the light source control circuit allows the light source to be lit during a light-on period, the light-on period being provided so as to be separated by a predetermined period from an end of the selection period in the subframe period.

According to a second aspect of the present invention, in the first aspect of the present invention,

the scanning signal line drive circuit selectively drives all of the plurality of scanning signal lines again during a reselection period provided after the selection period.

According to a third aspect of the present invention, in the second aspect of the present invention,

each of the pixel formation portions includes a liquid crystal element whose light transmittance is controlled, and

the video signal line drive circuit outputs the plurality of video signals such that polarities of liquid crystal drive voltages are same between the selection period and the reselection period in the subframe period, the liquid crystal drive voltages being generated based on the respective video signals.

According to a fourth aspect of the present invention, in the first aspect of the present invention,

each of the pixel formation portions includes a liquid crystal element whose light transmittance is controlled, and

the video signal line drive circuit outputs the plurality of video signals such that polarities of liquid crystal drive voltages are alternately reversed on a subframe-period-by-subframe-period basis where a same color is assigned, the liquid crystal drive voltages being generated based on video signals representing an image of the color, and that there are more cases in which polarities of liquid crystal drive voltages are reversed between adjacent subframe periods in a same frame period than a case in which polarities of liquid crystal drive voltages are not reversed between adjacent subframe periods in a same frame period.

According to a fifth aspect of the present invention, in the first aspect of the present invention,

the light source control circuit assigns
three colors including red, green, and blue, or
four colors where one of white, yellow, magenta, and cyan is added to red, green, and blue, or
five to seven colors where at least one of yellow, magenta, and cyan is added to red, green, blue, and white,

to the plurality of subframe periods one color by one color in predetermined order.

According to a sixth aspect of the present invention, in the first aspect of the present invention,

the light source control circuit assigns at least one of the plurality of colors twice in one frame period.

According to a seventh aspect of the present invention, in the sixth aspect of the present invention,

the light source control circuit repeatedly assigns four colors where one of white, yellow, magenta, and cyan is added to red, green, and blue, to subframe periods one color by one color in predetermined order, the subframe periods being obtained by dividing one frame period into five.

According to an eighth aspect of the present invention, in the first aspect of the present invention,

the light source control circuit sets, based on setting information of a color temperature provided from an external source, lengths of the light-on periods in the subframe periods for the respective colors such that the images are displayed at the color temperature.

A ninth aspect of the present invention is directed to a display method for a display device that includes a plurality of pixel formation portions arranged along a plurality of video signal lines for transmitting a plurality of video signals and along a plurality of scanning signal lines intersecting the plurality of video signal lines, divides one frame period into a plurality of subframe periods, and displays an image of any of a plurality of colors on a subframe-period-by-subframe-period basis, the display method including:

a video signal line driving step of driving the plurality of video signal lines, based on the plurality of video signals;

a scanning signal line driving step of selectively driving the plurality of scanning signal lines;

a display controlling step of outputting image signals for the video signal line driving step based on an input signal, the image signals being for controlling light transmittances of the plurality of pixel formation portions such that the image is displayed on a subframe-period-by-subframe-period basis; and

a light source controlling step of assigning any of the plurality of colors on a subframe-period-by-subframe-period basis and controlling a light source to emit light of the assigned color, the light source being configured to emit light that is to be transmitted through the pixel formation portions, wherein

in the scanning signal line driving step, all of the plurality of scanning signal lines are selectively driven during a selection period, the selection period being shorter in length than first half of each of the subframe periods,

in the video signal line driving step, video signals for displaying an image of an assigned color are provided to the plurality of video signal lines every time the plurality of scanning signal lines are selectively driven in the scanning signal line driving step, and

in the light source controlling step, the light source is allowed to be lit during a light-on period, the light-on period being provided so as to be separated by a predetermined period from an end of the selection period in the subframe period.

### Effects of the Invention

According to the first aspect of the present invention, a scanning period in each subframe period is set to be shorter in length than half of the subframe period, and a light-on period is set so as to be separated by a predetermined period from the end of the first scanning period and to be shorter in length than a lightable period. Hence, color mixture with a color in a previous subframe period can be prevented while a reduction in display luminance is prevented. Accordingly, accurate gray scale representation can be implemented.

According to the second aspect of the present invention, a scanning period in each subframe period is set to be shorter in length than half of the subframe period, and such two scanning periods are provided. By this, pixel voltages to be provided are securely written. As a result, an image can be displayed with desired proper gray scale.

According to the third aspect of the present invention, a single secure write can be implemented by two charging operations. In addition, even when such driving is performed, alternating-current driving of a display element such as a liquid crystal can be performed.

According to the fourth aspect of the present invention, polarities of liquid crystal drive voltages generated based on video signals are alternately reversed on a subframe-period-by-subframe-period basis where the same color is assigned, the video signals representing an image of the color. Hence, a bias in color (gray scale) based on a difference in polarity can be prevented. In addition, there are more cases in which polarities of liquid crystal drive voltages are reversed between adjacent subframe periods in the same frame period than a case in which the polarities of liquid crystal drive voltages are not reversed between adjacent subframe periods in the same frame period. Hence, sufficient alternating-current driving of a display element such as a liquid crystal can be sufficiently performed.

According to the fifth aspect of the present invention, high-quality color display can be easily performed by assigning three colors including red, green, and blue, which are used in a common field-sequential-system display device, or four colors where one of white, yellow, magenta, and cyan is added to red, green, and blue, or five to seven colors where at least one of yellow, magenta, and cyan is added to red, green, blue, and white, to a plurality of subframe periods in predetermined order.

According to the sixth aspect of the present invention, at least one of a plurality of colors is assigned twice in one frame period. Hence, a repetition frequency of the same color increases, enabling to prevent flicker.

According to the seventh aspect of the present invention, four colors where one of white, yellow, magenta, and cyan is added to red, green, and blue are repeatedly assigned in predetermined order to subframe periods which are obtained by dividing one frame period into five. By this, flicker can be prevented by a color configuration of a common field-sequential-system display device.

According to the eighth aspect of the present invention, since the lengths of light-on periods in subframe periods for respective colors are set such that an image is displayed at a predetermined color temperature, a color temperature can be easily adjusted.

According to the ninth aspect of the present invention, the same effect as that obtained in the first aspect of the present invention can be provided in a display method.

### BRIEF DESCRIPTION OF THE DRAWINGS

FIG. 1 is a block diagram showing a configuration of a field-sequential-system liquid crystal display device according to a first embodiment of the present invention.

FIG. 2 is a diagram showing display colors for respective subframe periods, light-on periods thereof, etc., in the first embodiment.

FIG. 3 is a diagram showing display colors for respective subframe periods, light-on periods thereof, etc., in a variant of the first embodiment.

FIG. 4 is a diagram showing display colors for respective subframe periods, light-on periods thereof, etc., in a second embodiment of the present invention.

FIG. 5 is a diagram showing display colors for respective subframe periods, light-on periods thereof, etc., in a variant of the second embodiment.

FIG. 6 is a diagram showing display colors for respective subframe periods, light-on periods thereof, etc., in a third embodiment of the present invention.

FIG. 7 is a diagram showing display colors for respective subframe periods, light-on periods thereof, etc., in a variant of the third embodiment.

FIG. 8 is a diagram showing display luminance at the first row of a liquid crystal panel for each subframe period for when a red still image is displayed on a conventional field-sequential-system liquid crystal display device that sequentially displays red, green, and blue.

FIG. 9 is a diagram showing display luminance at the last row of the liquid crystal panel for each subframe period for when a red still image is displayed on the conventional liquid crystal display device.

### MODES FOR CARRYING OUT THE INVENTION

### 1. First embodiment

### 1.1 Configuration of a Liquid Crystal Display Device

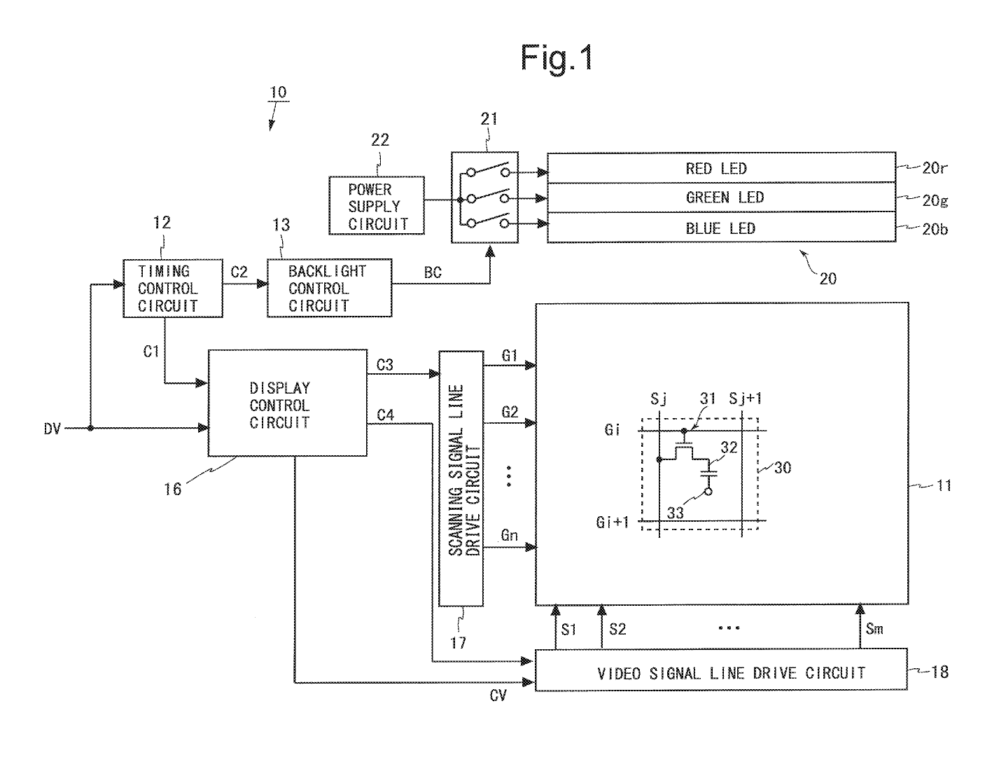

FIG. 1 is a block diagram showing a configuration of a field-sequential-system liquid crystal display device 10 according to a first embodiment of the present invention. The liquid crystal display device 10 shown in FIG. 1 performs color display using a field sequential color system where one frame period is divided into three subframe periods. The liquid crystal display device 10 includes a liquid crystal panel 11, a timing control circuit 12, a backlight control circuit 13, a scanning signal line drive circuit 17, a video signal line drive circuit 18, a backlight unit 20, a switch group 21, and a power supply circuit 22.

Although in the following description one frame period is 1/60 seconds and each subframe period is 1/180 seconds, the length of one frame period is not particularly limited as long as one frame period is a known display period. In addition, it is assumed that each of a red component (red gray scale value), a green component (green gray scale value), and a blue component (blue gray scale value) of an input signal which is inputted to the liquid crystal display device 10 from an external source is 8-bit data.

The liquid crystal panel 11 includes a plurality of (m) video signal lines S1 to Sm, a plurality of (n) scanning signal lines G1 to Gn, and a plurality of (m×n) pixel formation portions 30 provided at the respective intersections of the plurality of video signal lines S1 to Sm and the plurality of scanning signal lines G1 to Gn. Each pixel formation portion 30 includes a TFT 31 that functions as a switching element; a pixel electrode 32 connected to a drain terminal of the TFT 31; and a common electrode 33 that forms a liquid crystal capacitance, together with the pixel electrode 32. A gate terminal of the TFT 31 is connected to a scanning signal line Gi (1≦i≦n) and a source terminal of the TFT 31 is connected to a video signal line Sj (1≦j≦m).

An input signal DV is inputted to the timing control circuit 12 and a display control circuit 16 from an external source. The timing control circuit 12 generates control signals C1 and C2 based on the input signal DV such that timing of allowing a red LED (Light Emitting Diode) 20r, a green LED 20g, and a blue LED 20b which are included in the backlight unit 20 to emit light is synchronized with timing of outputting, by the video signal line drive circuit 18, red, green and blue driving image signals to the video signal lines S1 to Sm. The timing control circuit 12 provides the control signal C1 to the display control circuit 16 and provides the control signal C2 to the backlight control circuit 13.

The display control circuit 16 outputs, based on the input signal DV representing red (R), green (G), and blue (B) gray scale values, corrected video signals CV representing gray scale values that are corrected appropriately based on color temperature setting information provided from an external source. Note that the color temperature may be appropriately set by a user, or may be predetermined, or may be appropriately set based on information such as outside light illuminance.

In addition, the display control circuit 16 generates a control signal (e.g., a gate clock signal, etc.) C3 for the scanning signal line drive circuit 17 and a control signal (e.g., a source clock signal) C4 for the video signal line drive circuit 18, based on the control signal C1 provided from the timing control circuit 12 and the input signal DV inputted from the external source. The display control circuit 16 provides the control signal C4 to the video signal line drive circuit 18 and provides the control signal C3 to the scanning signal line drive circuit 17.

The scanning signal line drive circuit 17 outputs active scanning signals in turn to the scanning signal lines G1 to Gn, based on the control signal C3. The video signal line drive circuit 18 generates driving image signals based on the corrected video signals CV, and outputs the driving image signals to the video signal lines S1 to Sm at timing that is determined by the control signal C4. The driving image signals outputted to the video signal lines S1 to Sm are provided to pixel capacitances through TFTs 31 connected to an active one of the scanning signal lines G1 to Gn. By this, voltages generated depending on the driving image signals are applied to a liquid crystal and the transmittance of the liquid crystal changes depending on the applied voltages and thus an image is displayed on the liquid crystal panel 11.

Note that unlike a common configuration, the scanning signal line drive circuit 17 of the present embodiment is configured to select all pixel formation portions and then continuously select all pixel formation portions once again during one subframe period. A detailed description will be made later.

In general, a liquid crystal display device performs alternating-current driving in order to suppress deterioration of a liquid crystal and maintain display quality. However, in an active-type liquid crystal display device, since the characteristics of switching elements such as TFTs provided for each pixel are not sufficient, even when the positive and negative polarities of video signals to be outputted from a video signal line drive circuit that applies voltages to video signal lines of a liquid crystal panel, i.e., the positive and negative polarities of applied voltages with a common potential as a reference, are symmetrical, the transmittance of a liquid crystal layer does not completely become symmetrical with respect to positive and negative data voltages. Due to this, in a driving system in which the polarities of applied voltages to a liquid crystal are reversed on a frame-by-frame basis (frame-reversal driving system), flicker may occur in display performed by the liquid crystal panel. Hence, the present embodiment adopts, as an alternating-current driving system, a driving system (called an “n-line-reversal driving system”) in which, while the positive and negative polarities of applied voltages are reversed every n horizontal scanning line (n is a natural number greater than or equal to 1), the positive and negative polarities are also reversed every one frame. Note that it is also possible to adopt a driving system (called an “n-dot-reversal driving system”) in which, while the positive and negative polarities of applied voltages are reversed every n pixel, the n pixels being adjacent to each other in a vertical/horizontal direction, the positive and negative polarities are also reversed every one frame. Although in the following, for simplification of description, the expression “the polarities in a predetermined period are reversed” may be used, it strictly means that the polarity of a liquid crystal drive voltage for each pixel is reversed during a predetermined period, and thus, the polarities of all pixels do not need to coincide with each other.

The backlight unit 20 includes the red LED (Light Emitting Diode) 20r, the green LED 20g, and the blue LED 20b which are disposed two-dimensionally. The red LED 20r, the green LED 20g, and the blue LED 20b are independently connected to the power supply circuit 22 through the switch group 21. The backlight control circuit 13 generates a backlight control signal BC for appropriately turning on (bringing into a conduction state) each switch included in the switch group 21 on a subframe-period-by-subframe-period basis, based on the control signal C2 provided from the timing control circuit 12, and provides the backlight control signal BC to the switch group 21.

The switch group 21 connects one or more of the red LED 20r, the green LED 20g, and the blue LED 20b to the power supply circuit 22 at appropriate timing, based on the backlight control signal BC. A power supply voltage is provided to the LED (s) connected to the power supply circuit 22. By this, one or more of the red LED 20r, the green LED 20g, and the blue LED 20b emit light, as will be described later, in accordance with timing of applying driving image signals to the video signal lines S1 to Sm, and one or more of red, green, and blue lights are irradiated from the back of the liquid crystal panel 11 on a subframe-period-by-subframe-period basis. Note that, though not adopted in the present embodiment, when red, green, and blue lights are irradiated at a time, the colors of the lights are mixed together, by which white becomes a display color. In this case, in order to display the white, a white LED may be newly provided. In addition, as the light sources included in the backlight unit 20, instead of the red, green, and blue LEDs 20r, 20g, and 20b, known light sources such as red, green, and blue CCFLs (Cold Cathode Fluorescent Lamps) may be used.

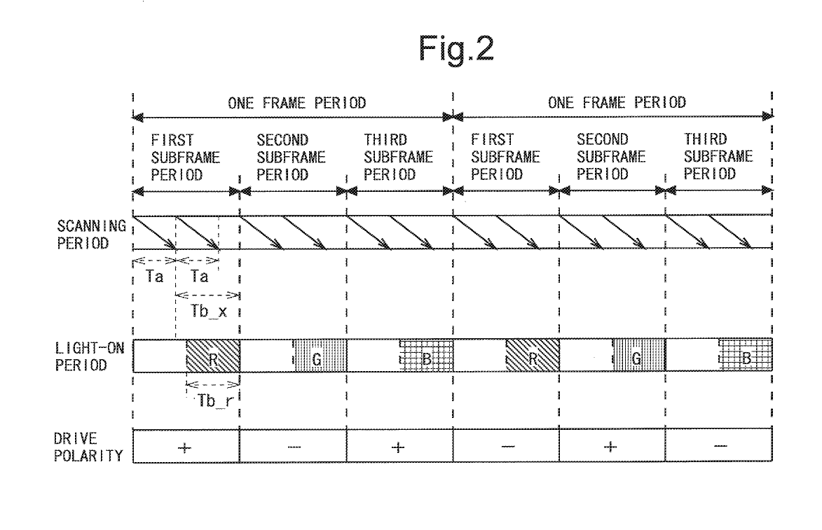

The liquid crystal display device 10 of the present embodiment divides one frame period into a first to a third subframe period and displays display colors which are assigned to the respective subframe periods, in order shown in FIG. 2. With reference to FIG. 2, display performed during each subframe period will be described below.

### 1.2 Display Performed During Each Subframe Period

FIG. 2 is a diagram showing display colors for respective subframe periods, light-on periods thereof, etc. As shown in FIG. 2, one frame period is divided into three subframe periods, a first to a third subframe period. The first half of each subframe period is a non-light-on period, and the second half of each subframe period is a light-on period. In FIG. 2, a red light-on period in the first subframe period is shaded by oblique lines, and the length of the light-on period is Tb_r. Note that the second and third subframe periods are also the same except that display colors are different, and thus, description thereof is omitted.

The reason that the first half of each subframe period is a non-light-on period as shown in FIG. 2 is to prevent a reduction in color reproducibility which is caused by color mixture with a display color in a previous frame. Note that the non-light-on period shown in FIG. 2 is 1/2 of the subframe period, but the length thereof is an example and thus is set to an appropriate length as will be described later.

In addition, during the first half of each subframe period, a voltage corresponding to a driving image signal (here, a corrected video signal CV) is applied to a pixel capacitance of each pixel formation portion. As described previously, the present embodiment adopts a configuration in which a driving image signal is provided twice to each pixel capacitance during each subframe period. A write to the pixel capacitances is indicated by an arrow in the “scanning period” field of FIG.

2. Specifically, the first (left) arrow in the scanning period shown in FIG. 2 indicates that scanning is performed during the first scanning period Ta to select all pixel formation portions in turn from the upper left to lower right of a screen, and the next arrow indicates that the second scanning is performed during the second scanning period Ta to select all pixel formation portions in turn from the upper left to lower right of the screen.

The reason why driving image signals of the same voltage are provided twice is to securely charge (write) a pixel voltage in a pixel capacitance. As described previously, since the length of each subframe period is 1/180 seconds, in order to take a sufficient length of a light-on period which is the second half, it is desirable to complete charging of all pixel capacitances in the first half of the subframe period. However, since the scanning period Ta of the present embodiment is set to be shorter in length than the length of half of the subframe period, a write to the pixel capacitances may not be completed in (one) scanning period Ta, depending on the characteristics of a liquid crystal to be used, the capability of a drive circuit, etc. Hence, a so-called double write where a pixel capacitance is charged by providing the same pixel voltage again thereto is performed. By this configuration, a pixel voltage to be provided is securely written to a pixel capacitance. As a result, a desired liquid crystal transmittance is set and an image is displayed with proper gray scale. Note that although it is preferred that the first and second scanning periods be consecutive, the two scanning periods do not need to be consecutive as long as they are present in the same subframe period.

In addition, as shown in FIG. 2, the polarity of the driving image signals with the common potential as a reference is reversed on a subframe-period-by-subframe-period basis, but is not reversed between the first and second scanning periods. This is because such driving is ideal for implementing a single (secure) write by two charging operations. In addition, even when such driving is performed, since the polarity is reversed on a subframe-period-by-subframe-period basis, alternating-current driving of the liquid crystal is performed. Furthermore, since the polarities of driving image signals for writing the same color are reversed on a frame-period-by-frame-period basis, a bias in color (gray scale) based on a difference in polarity does not occur.

As described above, during two scanning periods Ta provided in the first subframe period, each pixel formation portion 30 is driven twice based on a gray scale value indicating red of a corrected video signal CV transmitted from the display control circuit 16. In FIG. 2, the length of a lightable period after the driving is represented as Tb_x. The red LED 20r emits light during a light-on period Tb_r which is shorter than the lightable period Tb_x, after a predetermined period from the first scanning period. In a likewise manner, during two scanning periods provided in the second subframe period, each pixel formation portion 30 is driven based on a gray scale value indicating green of a corrected video signal CV, and the green LED 20g emits light during a light-on period which takes place after the predetermined period from the first scanning period. During two scanning periods provided in the third subframe period, each pixel formation portion 30 is driven based on a gray scale value indicating blue of a corrected video signal CV, and the blue LED 20b emits light during a light-on period which takes place after the predetermined period from the first scanning period.

Here, the reason why the above-described light-on period is set so as to be separated by the predetermined period from the end of the first scanning period and to be shorter than the lightable period Tb_x is to prevent color mixture with a color in a previous subframe period. That is, as described previously with reference to FIG. 9, since a transmittance of the liquid crystal panel that is set in the last subframe period does not change instantaneously, at the last row of the liquid crystal panel, the transmittance may not reach a value determined depending on gray scale which is represented by corrected video signals CV provided. Therefore, taking into account liquid crystal response, a light-on period is provided so as to be separated by the predetermined period from the end of the first scanning period. By this, color mixture is prevented, enabling to implement accurate gray scale representation.

Note that in the description the above-described light-on period is fixed in each subframe period. However, a case may be considered in which display luminance is given priority over the prevention of color mixture as described above (e.g., due to a reason such as high surrounding illuminance). In that case, it is desirable to increase the luminance of the liquid crystal panel 11 by setting the length of the light-on period to be close to the length of the lightable period Tb_x. Hence, the display control circuit 16 of the present embodiment is configured to be able to change the length of the above-described light-on period based on an instruction from an external source, etc. Specifically, for example, the display control circuit 16 allows a counter circuit to operate with reference to a vertical synchronizing signal of a subframe period, and controls light-on timing which is a start point in time of a light-on period and light-off timing which is an end point in time of the light-on period, based on a counter value obtained by the counter circuit. Note that this configuration is an example and various known configurations can be applied.

In addition, in order to completely prevent color mixture to implement accurate gray scale representation, it is preferred to start a light-on period further after a lapse of a predetermined period of time from the end of the second scanning period. However, in this case, since the length of the light-on period becomes very short, display luminance becomes insufficient in many cases. Hence, the present embodiment adopts a configuration in which a light-on period is provided so as to be separated by the predetermined period from the end of the first scanning period.

Although in the description the length of the above-described light-on period is the same between subframe periods, the length of the light-on period may be changed on a color-by-color basis, depending on a color temperature setting (white balance setting) which is set by a source external to the device (or which is calculated based on a predetermined parameter). In general, the color temperature setting is, in many cases, implemented by adjusting the gray scale of each color. However it is, in some cases, implemented by controlling the drive current of each color LED in the backlight unit 20. In this regard, the former configuration requires complex gray scale computation, and the latter configuration has difficulty in adjustment because a relationship between the drive current of the LEDs and luminance is nonlinear. However, since a relationship between the length of the light-on periods and luminance is linear, by a configuration in which the length of the light-on period for each color is set in the manner described in the present embodiment, a color temperature setting can be easily implemented.

### 1.3 Effects of the First Embodiment

As described above, according to the liquid crystal display device 10 of the present embodiment, by setting a scanning period in each subframe period to be shorter in length than half of the subframe period and providing two consecutive scanning periods which are thus set, pixel voltages to be provided are securely written to the pixel capacitances. As a result, an image can be displayed with desired proper gray scale. In addition, since a light-on period is set so as to be separated by a predetermined period from the end of the first scanning period and to be shorter in length than a lightable period Tb_x, color mixture with a color in a previous subframe period can be prevented while a reduction in the display luminance of the liquid crystal panel 11 is prevented. Accordingly, accurate gray scale representation can be implemented.

### 1.4 Variant of the First Embodiment

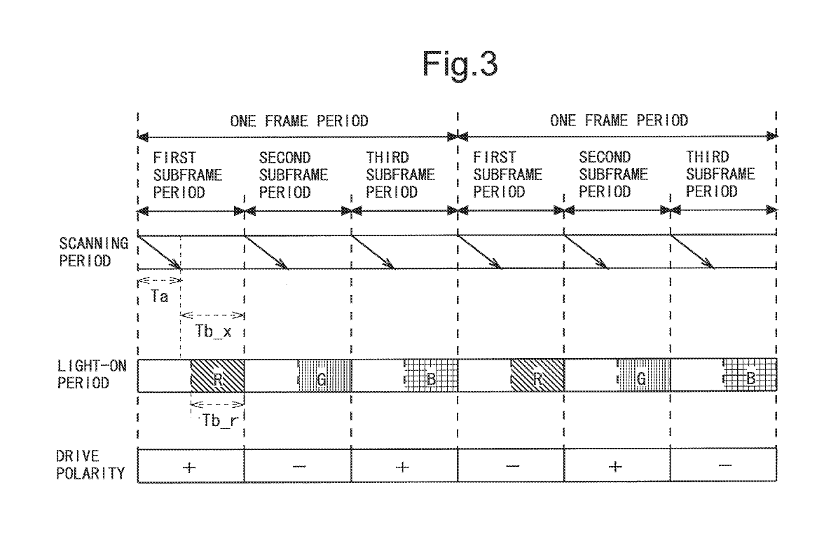

FIG. 3 is a diagram showing display colors for respective subframe periods, light-on periods thereof, etc., in a variant of the first embodiment. When comparing content shown in FIG. 3 with content of the first embodiment shown in FIG. 2, the only difference is that during each subframe period a driving image signal is provided only once to each pixel capacitance and the second write is omitted. Other content is the same. Therefore, description related to the same content is omitted.

It can be seen that in the present variant it is configured such that, as shown by an arrow indicating a scanning period in FIG. 3, a driving image signal is provided only once to each pixel capacitance during each subframe period, and the second write in the first embodiment is omitted.

A scanning period Ta of the above-described first embodiment and the present variant is set to be shorter in length than the length of half of a subframe period. However, the present variant differs from the case of the first embodiment in that there is no problem in the characteristics of a liquid crystal to be used, the capability of a drive circuit, etc., and thus, a write to the pixel capacitances is completed in the scanning period Ta. Therefore, without performing a double write such as that in the first embodiment, pixel voltages to be provided are securely written to the pixel capacitances. As a result, a desired liquid crystal transmittance is set. By this, an image is displayed with proper gray scale.

As described above, according to the liquid crystal display device 10 of the present variant, as in the case of the first embodiment, a light-on period is set so as to be separated by a predetermined period from the end of a scanning period and to be shorter in length than a lightable period Tb_x, and thus, color mixture with a color in a previous subframe period can be prevented while a reduction in the display luminance of the liquid crystal panel 11 is prevented. Accordingly, accurate gray scale representation can be implemented.

### 2. Second Embodiment

### 2.1 Configuration of a Liquid Crystal Display Device

An overall configuration of a field-sequential-system liquid crystal display device according to a second embodiment of the present invention is the same as that of the case of the first embodiment (see FIG. 1), and the same operation is performed except that one frame period is divided into four subframe periods and white (W) is displayed in addition to red (R), green (G), and blue (B). Therefore, description of the same configuration and the same operation is omitted.

The liquid crystal display device of the present embodiment differs from that of the case of the first embodiment in a part of the operation of a display control circuit 16 regarding the use of four subframe periods. Specifically, the display control circuit 16 outputs corrected video signals CV representing the gray scale values of a total of four types of colors (RGBW), i.e., the gray scale value of white (W) and the corrected gray scale values of red, green, and blue, based on an input signal DV representing the gray scale values of red (R), green (G), and blue (B). A method for calculating, from input gray scale values of a certain pixel including three primary colors (RGB), display gray scale values of the pixel including four display colors (RGBW) is known. For example, gray scale values including four display colors (RGBW) are generated from certain gray scale values including three primary colors (RGB), based on a predetermined color allocation algorithm. The color allocation algorithm may be any known algorithm. For example, taking into account color balance between colors, gamma characteristics, etc., over the entire screen, a predetermined amount of an achromatic color component, i.e., white (W), is extracted, and gray scale values including four display colors (RGBW) are determined based on gray scale values (RGB) where the achromatic color component is removed. The thus determined gray scale values are provided as corrected video signals CV to a video signal line drive circuit 18.

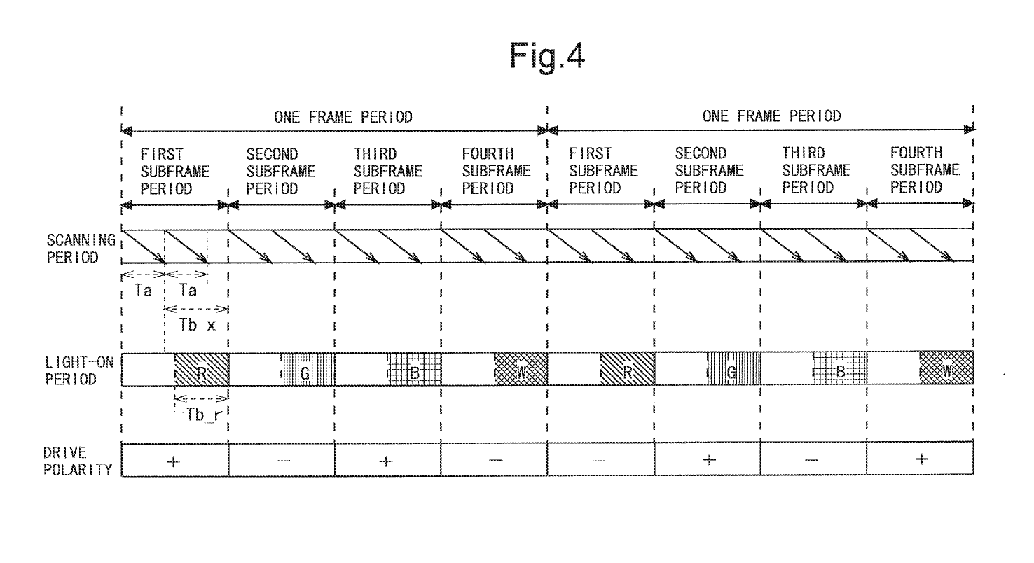

A liquid crystal display device 10 of the present embodiment divides one frame period into a first to a fourth subframe period and displays display colors assigned to the respective subframe periods, in order shown in FIG. 4. With reference to FIG. 4, display performed during each subframe period will be described below.

### 2.2 Display Performed During Each Subframe Period

FIG. 4 is a diagram showing display colors for respective subframe periods, light-on periods thereof, etc. As shown in FIG. 4, one frame period is divided into four subframe periods, a first to a fourth subframe period. The first half of each subframe period is a non-light-on period, and the second half of each subframe period is a light-on period. In FIG. 4, a red light-on period in the first subframe period is shaded by oblique lines, and the length of the light-on period is Tb_r. Note that the second to fourth subframe periods are also the same except that display colors are different, and thus, description thereof is omitted.

As in that shown in FIG. 2, as shown in FIG. 4, the first half of each subframe period is a non-light-on period. In addition, a configuration is adopted in which a voltage corresponding to a driving image signal (here, a corrected video signal CV) is provided twice to a pixel capacitance of each pixel formation portion during the first half of each subframe period. The reason therefore is the same as that of the case of the first embodiment.

In addition, as in that shown in FIG. 2, as shown in FIG. 4, the polarity of the driving image signals with the common potential as a reference is reversed on a subframe-period-by-subframe-period basis in one frame period, but is not reversed between the first and second scanning periods. Here, unlike the case of the first embodiment, in the second embodiment there are an even number of subframe periods. Hence, in adjacent frame periods, the polarity in the last subframe period (a fourth subframe period) in a preceding frame period is the same as the polarity in the first subframe period (a first subframe period) in a subsequent frame period. However, even when such driving is performed, since the polarity is reversed on a subframe-period-by-subframe-period basis in one frame period, alternating-current driving of a liquid crystal is performed. Furthermore, since the polarities of driving image signals for writing the same color are reversed on a frame-period-by-frame-period basis, a bias in color (gray scale) based on a difference in polarity does not occur.

As described above, as in the case of the first embodiment, in the present embodiment, too, during two scanning periods Ta provided in the first subframe period, each pixel formation portion 30 is driven twice based on a gray scale value indicating red of a corrected video signal CV transmitted from the display control circuit 16. Then, a red LED 20r emits light during a light-on period Tb_r which is shorter than a lightable period Tb_x, after a predetermined period from the first scanning period. In a likewise manner, during the second subframe period, each pixel formation portion 30 is driven based on a gray scale value indicating green of a corrected video signal CV, and a green LED 20g emits light during a light-on period which takes place after the predetermined period from the first scanning period. During the third subframe period, each pixel formation portion 30 is driven based on a gray scale value indicating blue of a corrected video signal CV, and a blue LED 20b emits light during a light-on period which takes place after the predetermined period from the first scanning period.

In addition, during the newly provided fourth subframe period, each pixel formation portion 30 is driven based on a gray scale value indicating white of a corrected video signal CV, and the red LED 20r, the green LED 20g, and the blue LED 20b simultaneously emit light during a light-on period which takes place after the predetermined period from the first scanning period. Note that by the colors of lights from the LEDs mixed together, the lights become a white light.

Note that as in the case of the first embodiment, it is configured such that the length of the above-described light-on period can be changed based on an instruction from an external source, etc. In addition, the length of the above-described light-on period may be changed on a color-by-color basis, depending on a color temperature setting (white balance setting).

### 2.3 Effects of the Second Embodiment

As described above, according to the liquid crystal display device 10 of the present embodiment, as in the case of the first embodiment, by setting a scanning period in each subframe period to be shorter in length than half of the subframe period and providing two consecutive scanning periods which are thus set, pixel voltages to be provided are securely written to the pixel capacitances. As a result, an image can be displayed with desired proper gray scale. In addition, since a light-on period is set so as to be separated by a predetermined period from the end of the first scanning period and to be shorter in length than a lightable period Tb_x, color mixture with a color in a previous subframe period can be prevented while a reduction in the display luminance of the liquid crystal panel 11 is prevented. Accordingly, accurate gray scale representation can be implemented. Furthermore, since color variation is visually suppressed by assigning white, a color breakup phenomenon can be reduced.

### 2.4 Variant of the Second Embodiment

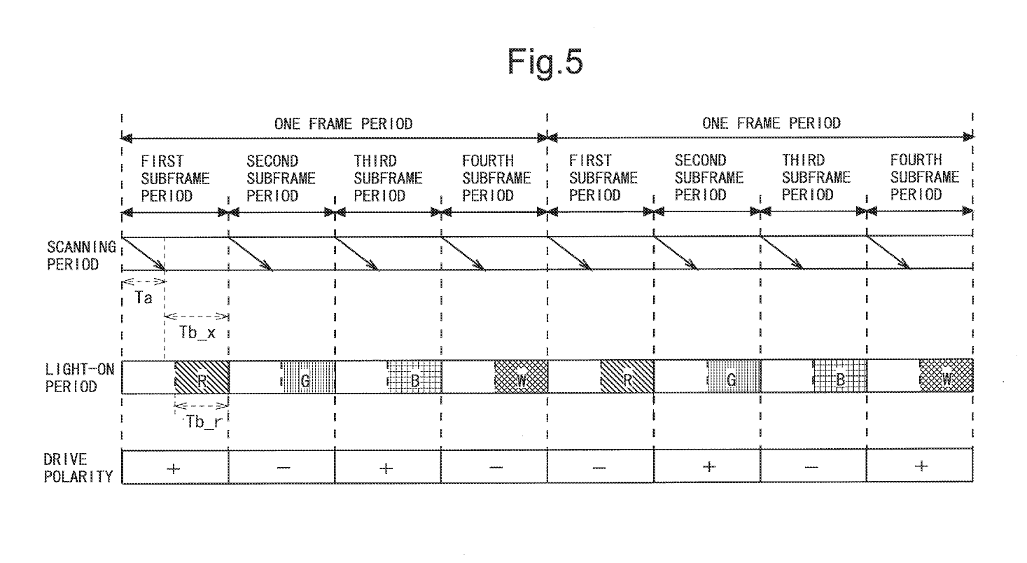

FIG. 5 is a diagram showing display colors for respective subframe periods, light-on periods thereof, etc., in a variant of the second embodiment. When comparing content shown in FIG. 5 with content of the second embodiment shown in FIG. 4, the only difference is that during each subframe period a driving image signal is provided only once to each pixel capacitance and the second write is omitted. Other content is the same. Therefore, description related to the same content is omitted. Note that when comparing the present variant with the variant of the first embodiment shown in FIG. 3, the only difference is that one frame period is divided into four subframe periods and white (W) is displayed in addition to red (R), green (G), and blue (B). Except for that, the same operation is performed and thus description of the same configuration and the same operation is omitted.

It can be seen that in the present variant it is configured such that, as shown by an arrow indicating a scanning period in FIG. 5, a driving image signal is provided only once to each pixel capacitance during each subframe period, and the second write in the second embodiment is omitted.

As described above, according to the liquid crystal display device 10 of the present variant, as in the case of the second embodiment, a light-on period is set so as to be separated by a predetermined period from the end of a scanning period and to be shorter in length than a lightable period Tb_x, and thus, color mixture with a color in a previous subframe period can be prevented while a reduction in the display luminance of the liquid crystal panel 11 is prevented. Accordingly, accurate gray scale representation can be implemented. In addition, a color breakup phenomenon can be reduced.

### 3. Third Embodiment

### 3.1 Configuration of a Liquid Crystal Display Device

An overall configuration of a field-sequential-system liquid crystal display device according to a third embodiment of the present invention is the same as that of the case of the first embodiment (see FIG. 1), and the same operation is performed except that one frame period is divided into five subframe periods and white (W) is displayed in addition to red (R), green (G), and blue (B). Therefore, description of the same configuration and the same operation is omitted. In addition, in the configuration of the present embodiment, the types of display colors are the same as those of the case of the second embodiment. However, the configuration of the present embodiment differs from that of the case of the second embodiment in that, since one frame period is divided into five subframe periods, the same color is assigned to two subframe periods included in one frame period.

Specifically, a display control circuit 16 of the present embodiment outputs corrected video signals CV representing the gray scale values of a total of four types of colors (RGBW), i.e., the gray scale value of white (W) and the corrected gray scale values of red, green, and blue, based on an input signal DV representing the gray scale values of red (R), green (G), and blue (B). As such, the number of display colors is the same as that of the second embodiment. However, any of the four types of colors (RGBW) is displayed twice during one frame period. Hence, gray scale values including four display colors (RGBW) are determined by generating gray scale values including four display colors (RGBW) based on a predetermined color allocation algorithm in the same manner as in the second embodiment and then setting the gray scale value of a color that is to be displayed twice typically to 1/2. The thus determined gray scale values are provided as corrected video signals CV to the video signal line drive circuit 18. Note that the reason that the gray scale value of a color that is to be displayed twice is set (typically) to 1/2 is because a light-on period becomes double. Note that other factors may be taken into account, and the above-described gray scale value can be set in any manner as long as the same luminance as that obtained when a color is displayed once can be consequently obtained.

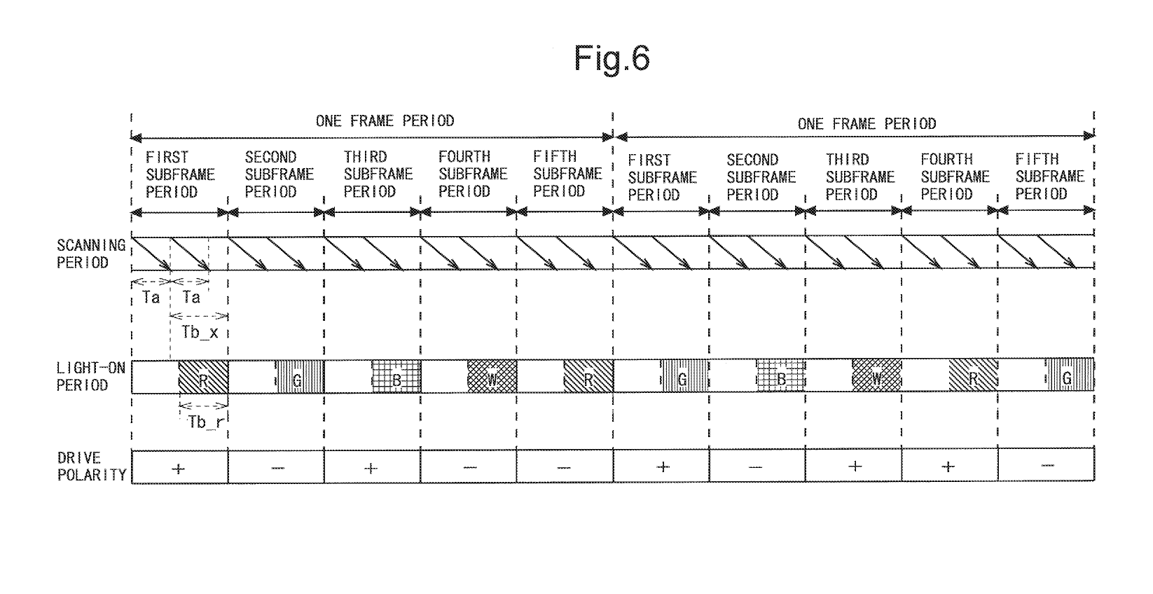

A liquid crystal display device 10 of the present embodiment divides one frame period into a first to a fifth subframe period and displays display colors assigned to the respective subframe periods, in order shown in FIG. 6. With reference to FIG. 6, display performed during each subframe period will be described below.

### 3.2 Display Performed During Each Subframe Period

FIG. 6 is a diagram showing display colors for respective subframe periods, light-on periods thereof, etc. As shown in FIG. 6, one frame period is divided into five subframe periods, a first to a fifth subframe period. The first half of each subframe period is a non-light-on period, and the second half of each subframe period is a light-on period. In FIG. 6, a red light-on period in the first subframe period is shaded by oblique lines, and the length of the light-on period is Tb_r. Note that the second to fifth subframe periods are also the same except that display colors are different, and thus, description thereof is omitted.

As shown in FIG. 6, during a total of 10 subframe periods in two consecutive frame periods, red (R), green (G), blue (B), and white (W) are assigned such that their order is repeated (in order of RGBWRGBWRG . . . ). Therefore, red (R) is displayed twice during the first frame period (red is assigned to two subframe periods), and green (G) is displayed twice during the next frame period (green is assigned to two subframe periods). In this manner, though not shown, colors that are displayed twice go around in four consecutive frame periods, and the order of color assignment becomes the same between the fifth frame period and the first frame period. Assignment of the colors is repeated in such order.

Here, when assignment of the colors is repeated in order such as that described above, the same color is displayed every four subframe periods. Then, since the length of the subframe periods is 1/300 seconds, a cycle in which the same color is displayed, i.e., a repetition frequency, is 75 [Hz]. In general, when a repetition frequency at which a flash occurs exceeds 70 [Hz], flicker cannot be perceived by the eyes. Since the above-described repetition frequency (75 [Hz]) at which the same color is displayed exceeds the frequency (70 [Hz]), according to the present embodiment, flicker is eliminated or reduced.

In addition, as in that shown in FIG. 4, as shown in FIG. 6, the polarity of the driving image signals with the common potential as a reference is basically reversed on a subframe-period-by-subframe-period basis in one frame period, but is not reversed between the first and second scanning periods. Here, unlike the case of the first or second embodiment, in the third embodiment a frame period includes two subframe periods for displaying the same color. When the same color is displayed, the polarity of the driving image signals is reversed. As a result, there arises a case in which the polarity of the driving image signals is the same between adjacent subframe periods. For example, FIG. 6 shows that the polarities in the third and fourth subframe periods in the second frame period are the same. However, even when such driving is performed, since the polarity is reversed on a subframe-period-by-subframe-period basis where the same color is assigned, alternating-current driving of a liquid crystal is performed. Furthermore, since the polarities of driving image signals for writing the same color are reversed, a bias in color (gray scale) based on a difference in polarity does not occur.

However, if there are more cases in which the polarities of driving image signals are not reversed between adjacent subframe periods in the same frame period than a case in which the polarities of driving image signals are reversed between adjacent subframe periods in the same frame period, then the overall number of polarity reversals decreases. Thus, in order to perform sufficient alternating-current driving of a liquid crystal, it is preferred to perform polarity reversal such that there are more cases in which the polarities of driving image signals are reversed between adjacent subframe periods in the same frame period than a case in which the polarities of driving image signals are not reversed between adjacent subframe periods in the same frame period.

Furthermore, as in that shown in FIG. 4, as shown in FIG. 6, the first half of each subframe period is a non-light-on period. In addition, a configuration is adopted in which a voltage corresponding to a driving image signal (here, a corrected video signal CV) is provided twice to a pixel capacitance of each pixel formation portion during the first half of each subframe period. The reason therefore is the same as that of the case of the first embodiment.

As described above, as in the case of the second embodiment, in the present embodiment, too, during two scanning periods Ta provided in the first subframe period, each pixel formation portion 30 is driven twice based on a gray scale value indicating red of a corrected video signal CV transmitted from the display control circuit 16. Then, a red LED 20r emits light during a light-on period Tb_r which is shorter than a lightable period Tb_x, after a predetermined period from the first scanning period. The second to fourth subframe periods are also the same.

Then, for example, in the first frame period in FIG. 6, during the newly provided fifth subframe period, each pixel formation portion 30 is driven based on a gray scale value indicating red of a corrected video signal CV, and the red LED 20r emits light during a light-on period which takes place after a predetermined period from the first scanning period.

Note that as in the case of the first embodiment, it is configured such that the length of the above-described light-on period can be changed based on an instruction from an external source, etc. In addition, the length of the above-described light-on period may be changed on a color-by-color basis, depending on a color temperature setting (white balance setting).

### 3.3 Effects of the Third Embodiment

As described above, according to the liquid crystal display device 10 of the present embodiment, as in the case of the second embodiment, by setting a scanning period in each subframe period to be shorter in length than half of the subframe period and providing two consecutive scanning periods which are thus set, pixel voltages to be provided are securely written to the pixel capacitances. As a result, an image can be displayed with desired proper gray scale. In addition, since a light-on period is set so as to be separated by a predetermined period from the end of the first scanning period and to be shorter in length than a lightable period Tb_x, color mixture with a color in a previous subframe period can be prevented while a reduction in the display luminance of the liquid crystal panel 11 is prevented. Accordingly, accurate gray scale representation can be implemented. Furthermore, since color variation is visually suppressed by assigning white, a color breakup phenomenon can be reduced. Moreover, since a repetition frequency at which the same color is displayed can be increased, flicker can be eliminated or reduced.

### 3.4 Variant of the Third Embodiment

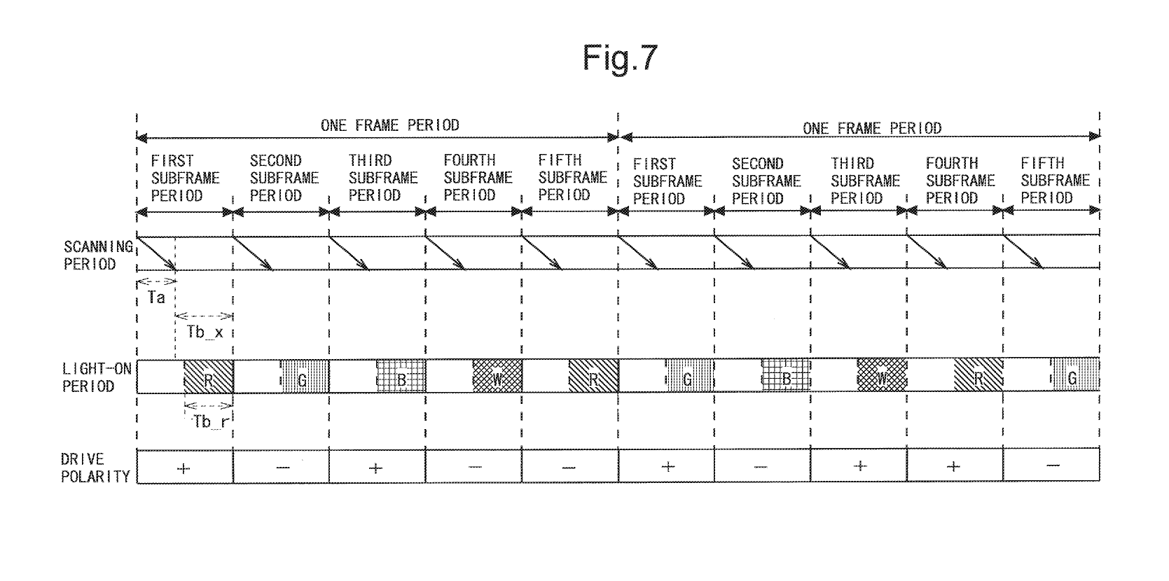

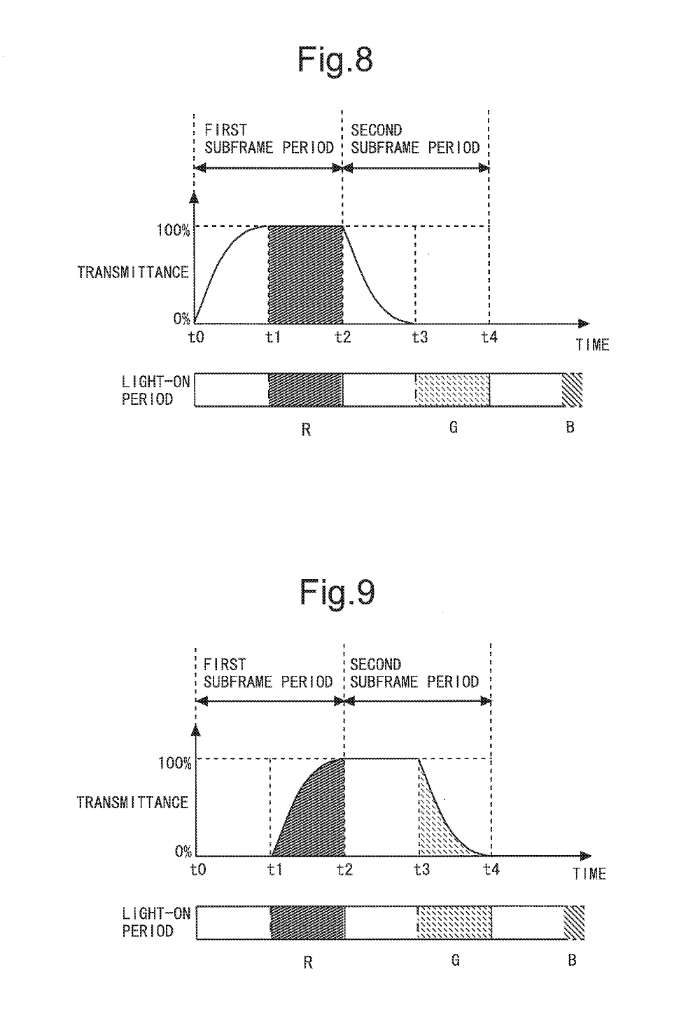

FIG. 7 is a diagram showing display colors for respective subframe periods, light-on periods thereof, etc., in a variant of the third embodiment. When comparing content shown in FIG. 7 with content of the third embodiment shown in FIG. 6, the only difference is that during each subframe period a driving image signal is provided only once to each pixel capacitance and the second write is omitted. Other content is the same. Therefore, description related to the same content is omitted. Note that when comparing the present variant with the variant of the first embodiment shown in FIG. 3, the only difference is that one frame period is divided into five subframe periods and white (W) is displayed in addition to red (R), green (G), and blue (B). Except for that, the same operation is performed and thus description of the same configuration and the same operation is omitted.

It can be seen that in the present variant it is configured such that, as shown by an arrow indicating a scanning period in FIG. 7, a driving image signal is provided only once to each pixel capacitance during each subframe period, and the second write in the third embodiment is omitted.

As described above, according to the liquid crystal display device 10 of the present variant, as in the case of the third embodiment, a light-on period is set so as to be separated by a predetermined period from the end of a scanning period and to be shorter in length than a lightable period Tb_x, and thus, color mixture with a color in a previous subframe period can be prevented while a reduction in the display luminance of the liquid crystal panel 11 is prevented. Accordingly, accurate gray scale representation can be implemented. In addition, a color breakup phenomenon can be reduced. Furthermore, flicker can be eliminated or reduced.

### 4. Other Variants

Although in the above-described embodiments a liquid crystal display device is described as an example, a liquid crystal does not necessarily need to be used as long as a display device uses a field sequential system. A configuration using any known shutter element in place of a liquid crystal can also be adopted. Note, however, that in order to apply the present invention, it is preferred to have such a response characteristic that gray scale for a certain subframe period affects gray scale for the next subframe period as in the case of a liquid crystal.

The above-described embodiments adopt a configuration using three colors, red (R), green (G), and blue (B), or four colors, red (R), green (G), blue (B), and white (W). However, a configuration further using a known color such as yellow, cyan, or magenta may be adopted. The number and types of colors are not limited as long as the above-described configuration specific to the present invention is included. For example, a configuration can also be adopted that uses five to seven colors where at least one of yellow, magenta, and cyan is added to red (R), green (G), blue (B), and white (W). In addition, although the above-described second or third embodiment adopts a configuration using four colors, red (R), green (G), blue (B), and white (W), a configuration using a known color such as yellow, cyan, or magenta in place of white may be adopted. The types of colors are not limited as long as the above-described configuration specific to the present invention is included.

### DESCRIPTION OF REFERENCE CHARACTERS

10: LIQUID CRYSTAL DISPLAY DEVICE
11: LIQUID CRYSTAL PANEL
13: BACKLIGHT CONTROL CIRCUIT
16: DISPLAY CONTROL CIRCUIT
17: SCANNING SIGNAL LINE DRIVE CIRCUIT
18: VIDEO SIGNAL LINE DRIVE CIRCUIT
20: BACKLIGHT UNIT
21: SWITCH GROUP
C1 to C4: CONTROL SIGNAL
BC: BACKLIGHT CONTROL SIGNAL
G1 to Gn: SCANNING SIGNAL LINE
S1 to Sm: VIDEO SIGNAL LINE
DV: VIDEO SIGNAL
CV: CORRECTED VIDEO SIGNAL
Ta: SCANNING PERIOD
Tb₁₃ x: LIGHTABLE PERIOD
Tb_r: (RED) LIGHT-ON PERIOD

1. A display device that divides one frame period into a plurality of subframe periods and displays an image of any of a plurality of colors on a subframe-period-by-subframe-period basis, the display device comprising:
a plurality of pixel formation portions arranged along a plurality of video signal lines for transmitting a plurality of video signals and along a plurality of scanning signal lines intersecting the plurality of video signal lines;
a video signal line drive circuit configured to drive the plurality of video signal lines, based on the plurality of video signals;
a scanning signal line drive circuit configured to selectively drive the plurality of scanning signal lines;
a display control circuit configured to provide image signals to the video signal line drive circuit based on an input signal, the image signals being for controlling light transmittances of the plurality of pixel formation portions such that the image is displayed on a subframe-period-by-subframe-period basis;
a light source configured to emit light that is to be transmitted through the pixel formation portions; and
a light source control circuit configured to assign any of the plurality of colors on a subframe-period-by-subframe-period basis and control the light source to emit light of the assigned color, wherein
the scanning signal line drive circuit selectively drives all of the plurality of scanning signal lines during a selection period, the selection period being shorter in length than first half of each of the subframe periods,
the video signal line drive circuit provides video signals for displaying an image of an assigned color to the plurality of video signal lines every time the plurality of scanning signal lines are selectively driven by the scanning signal line drive circuit, and
the light source control circuit allows the light source to be lit during a light-on period, the light-on period being provided so as to be separated by a predetermined period from an end of the selection period in the subframe period.

2. The display device according to claim 1, wherein the scanning signal line drive circuit selectively drives all of the plurality of scanning signal lines again during a reselection period provided after the selection period.

3. The display device according to claim 2, wherein
each of the pixel formation portions includes a liquid crystal element whose light transmittance is controlled, and
the video signal line drive circuit outputs the plurality of video signals such that polarities of liquid crystal drive voltages are same between the selection period and the reselection period in the subframe period, the liquid crystal drive voltages being generated based on the respective video signals.

4. The display device according to claim 1, wherein
each of the pixel formation portions includes a liquid crystal element whose light transmittance is controlled, and
the video signal line drive circuit outputs the plurality of video signals such that polarities of liquid crystal drive voltages are alternately reversed on a subframe-period-by-subframe-period basis where a same color is assigned, the liquid crystal drive voltages being generated based on video signals representing an image of the color, and that there are more cases in which polarities of liquid crystal drive voltages are reversed between adjacent subframe periods in a same frame period than a case in which polarities of liquid crystal drive voltages are not reversed between adjacent subframe periods in a same frame period.

5. The display device according to claim 1, wherein
the light source control circuit assigns
three colors including red, green, and blue, or
four colors where one of white, yellow, magenta, and cyan is added to red, green, and blue, or
five to seven colors where at least one of yellow, magenta, and cyan is added to red, green, blue, and white,
to the plurality of subframe periods one color by one color in predetermined order.

6. The display device according to claim 1, wherein the light source control circuit assigns at least one of the plurality of colors twice in one frame period.

7. The display device according to claim 6, wherein the light source control circuit repeatedly assigns four colors where one of white, yellow, magenta, and cyan is added to red, green, and blue, to subframe periods one color by one color in predetermined order, the subframe periods being obtained by dividing one frame period into five.

8. The display device according to claim 1, wherein the light source control circuit sets, based on setting information of a color temperature provided from an external source, lengths of the light-on periods in the subframe periods for the respective colors such that the images are displayed at the color temperature.

9. A display method for a display device that includes a plurality of pixel formation portions arranged along a plurality of video signal lines for transmitting a plurality of video signals and along a plurality of scanning signal lines intersecting the plurality of video signal lines, divides one frame period into a plurality of subframe periods, and displays an image of any of a plurality of colors on a subframe-period-by-subframe-period basis, the display method comprising:
a video signal line driving step of driving the plurality of video signal lines, based on the plurality of video signals;
a scanning signal line driving step of selectively driving the plurality of scanning signal lines;
a display controlling step of outputting image signals for the video signal line driving step based on an input signal, the image signals being for controlling light transmittances of the plurality of pixel formation portions such that the image is displayed on a subframe-period-by-subframe-period basis; and
a light source controlling step of assigning any of the plurality of colors on a subframe-period-by-subframe-period basis and controlling a light source to emit light of the assigned color, the light source being configured to emit light that is to be transmitted through the pixel formation portions, wherein
in the scanning signal line driving step, all of the plurality of scanning signal lines are selectively driven during a selection period, the selection period being shorter in length than first half of each of the subframe periods,
in the video signal line driving step, video signals for displaying an image of an assigned color are provided to the plurality of video signal lines every time the plurality of scanning signal lines are selectively driven in the scanning signal line driving step, and
in the light source controlling step, the light source is allowed to be lit during a light-on period, the light-on period being provided so as to be separated by a predetermined period from an end of the selection period in the subframe period.
